(19) United States
(12) Patent Application Publication
(10) Pub. No.: US 2008/0317923 A1
(43) Pub. Date: Dec. 25, 2008

(54) AROMA COMPOSITION FOR REDUCING OR SUPPRESSING AN UNDESIRED BITTER, ASTRINGENT IMPRESSION

(75) Inventors: Jakob Ley, Holzminden (DE); Kathrin Langer, Dassel (DE); Gerhard Krammer, Holzminden (DE); Gerald Reinders, Hoxter (DE); Gunter Kindel, Hoxter (DE); Christian Nolte, Holzminden (DE)

Correspondence Address: CONNOLLY BOVE LODGE & HUTZ LLP, 1875 EYE STREET, N.W., SUITE 1100, WASHINGTON, DC, 20006, US

(73) Assignee: SYMRISE GmbH & Co. KG, Holzminden (DE)

(21) Appl. No.: 12/141,982

(22) Filed: Jun. 19, 2008

Related U.S. Application Data
(60) Provisional application No. 60/944,854, filed on Jun. 19, 2007.

(51) Int. Cl. A23L 1/22

(52) U.S. Cl. 426/535; 426/534; 426/650; 426/538

(57) ABSTRACT

The invention relates to an aroma composition for reducing or suppressing a bitter, astringent impression in the oral cavity, comprising
(i) one or more salivatory aroma substances and/or flavorings and
(ii) one or more particular bitterness-masking aroma substances and/or flavorings
and optionally
(iii) one or more further aroma substances, wherein preferably at least one aroma substance is an aroma substance which suppresses malodors and optionally
(iv) one or more auxiliary substances or carriers.

The invention relates to an aroma composition for reducing or suppressing a bitter, astringent impression in the oral cavity, comprising (i) one or more salivatory aroma substances and/or flavorings and (ii) one or more specific bitterness-masking aroma substances and/or flavorings and optionally (iii) one or more further aroma substances and optionally (iv) one or more auxiliary substances or carriers. The invention further relates to a preparation comprising such an aroma composition, the use of an aroma composition for reducing or suppressing a bitter, astringent effect of a compound and a corresponding method of reducing or suppressing the bitter, astringent effect of a compound.

Foodstuffs or products consumed for pleasure often contain various bitter substances and astringent substances, which on the one hand are desirable and characteristic in moderation (for example caffeine in tea or coffee, tannins in red wine or green tea, quinine in bitter lemon beverages, saponins or isoflavonoids or the glycosides thereof in soy milk, hop extracts in beer), but on the other hand may also severely reduce value (for example flavonoid glycosides and, limonoids in citrus juices, bitter and/or astringent aftertaste of many artificial sweeteners such as aspartame or saccharin, hydrophobic amino acids and/or peptides in cheese). Often the unpleasant taste is additionally amplified by unpleasant odors, for example an additional so-called “beany” note in soy milk, which often tastes bitter and astringent, is described as unpleasant.

A bitter taste is caused by individual substances (for examples see below), which bind to specific bitterness receptors on taste cells (which are to be found in the “taste buds” on the tongue) and transmit a signal to the brain via neurochemical cascades, which signal causes a defensive reaction and a negative taste impression (cf. Wolfgang Meyerhof, Reviews of Physiology, Biochemistry and Pharmacology 2005, 154, 37-72).

An astringent taste is caused as a rule by precipitation of proline-rich proteins in the saliva by astringent substances, for example metal salts or tannins. The homogeneous saliva, which normally serves as a “lubricant”, then contains denatured proteins, which reduce lubricity and so leave behind a rough or dry feeling in the mouth, which is also felt to be astringent (Isabelle Lesschaeve and Ann C. Noble, American Journal of Clinical Nutrition 2005, 81, 3308-335S).

A number of approaches to bitterness reduction have been described (for example using hydroxyflavanones according to EP 1 258 200, γ-aminobutyric acid according to WO 2005/096841, hydroxyphenyl alkanediones according to WO 2007/003527, hydroxydeoxybenzoins according to WO 2006/106023, hydroxybenzoic acid vanillylamides according to WO 2006 024587, diacetyl trimers according to WO 2006/058893, 4-hydroxychalcone derivatives according to U.S. Provisional Application 60/894,557, additionally using nucleotides according to US 2002/0177576 or pyridinium salts as reported in Tomislav Soldo and Thomas Hofmann, J. Agric. Food Chem. 2005, 53, 9165-9171). However, the simultaneous suppression of severe astringency, which is generally not preferred by most consumers, is insufficient in the stated cases. Although the use of one of the stated selective bitterness masking agents may sometimes effectively reduce the bitter taste, for example in green tea or in soy milk, the astringent taste is thereby unhappily sometimes perceived as amplified and thus the result is still not an optimum product.

EP 1 258 200 describes combinations of bitterness-masking flavanones with fruit and edible acids (for example malic acid, acetic acid, citric acid, tartaric acid, succinic acid, adipic acid, phosphoric acid). Although the bitter taste may be reduced in this way, the acids in most cases contribute negatively to the perceived astringency due to their acidic taste, although they may at the same time stimulate salivation.

It was therefore the object of the present invention to indicate aroma compositions which may simultaneously reduce the bitter and the astringent impressions in particular in the oral cavity made by compounds and preparations, in particular foodstuffs and pharmaceutical products and products consumed for pleasure and in the best case scenario also suppress unpleasant odors.

Said object is achieved according to the invention by an aroma composition for reducing or suppressing a bitter, astringent impression in the oral cavity, comprising

(i) one or more salivatory aroma substances and/or flavorings and
(ii) one or more bitterness-masking aroma substances and/or flavorings in each case selected from the group consisting of nucleotides, such as for example adenosine 5′-monophosphate, cytidine 5′-monophosphate, inosine 5′-monophosphate, and the pharmaceutically acceptable salts thereof; lactisoles; 2,4-dihydroxybenzoic acid; 3-hydroxybenzoic acid; sodium salts, such as for example sodium chloride, sodium lactate, sodium citrate, sodium acetate, sodium gluconate; hydroxyflavanones, such as for example eriodictyol, homoeriodictyol, and the sodium salts thereof (in particular those described in EP 1 258 200, which is incorporated into this application by way of reference with regard to the corresponding compounds disclosed therein; hydroxybenzoic acid amides, such as for example 2,4-dihydroxybenzoic acid vanillylamide, 2,4-dihydroxybenzoic acid N-(4-hydroxy-3-methoxybenzyl)amide, 2,4,6-trihydroxybenzoic acid N-(4-hydroxy-3-methoxybenzyl)amide, 2-hydroxybenzoic acid N-(4-hydroxy-3-methoxybenzyl)amide, 4-hydroxybenzoic acid N-(4-hydroxy-3-methoxybenzyl)amide, 2,4-dihydroxybenzoic acid N-(4-hydroxy-3-methoxybenzyl)amide monosodium salt, 2,4-dihydroxybenzoic acid N-2-(4-hydroxy-3-methoxyphenyl)ethylamide, 2,4-dihydroxybenzoic acid N-(4-hydroxy-3-ethoxybenzyl)amide, 2,4-dihydroxybenzoic acid N-(3,4-dihydroxybenzyl)amide and 2-hydroxy-5-methoxy-N-[2-(4-hydroxy-3-methoxyphenyl)ethyl]amide; 4-hydroxybenzoic acid vanillylamide (in particular as described in WO 2006/024587, which is incorporated into this application by way of reference with regard to the corresponding compounds disclosed therein); hydroxydeoxybenzoins, such as for example 2-(4-hydroxy-3-methoxyphenyl)-1-(2,4,6-trihydroxyphenyl)ethanone, 1-(2,4-dihydroxyphenyl)-2-(4-hydroxy-3-methoxyphenyl)ethanone, 1-(2-hydroxy-4-methoxyphenyl)-2-(4-hydroxy-3-methoxyphenyl)ethanone) (in particular as described in WO 2006/106023, which is incorporated into this application by way of reference with regard to the corresponding compounds disclosed therein); hydroxyphenyl alkanediones, such as for example gingerdione-[2], gingerdione-[3], gingerdione-[4], dehydrogingerdione-[2], dehydrogingerdione-[3], dehydrogingerdione-[4]) (in particular as described in WO 2007/003527, which is incorporated into this application by way of reference with regard to the corresponding compounds disclosed therein); diacetyl trimers (in particular as described in WO 2006/058893, which is incorporated into this application by way of reference with regard to, the corresponding compounds disclosed therein); γ-aminobutyric acids (in particular as described in WO 2005/096841, which is incorporated into this application by, way of reference with regard to the corresponding compounds disclosed therein); divanillins (in particular as described in WO 2004/078302, which is incorporated into this application by way of reference with regard to the corresponding compounds disclosed therein) and hydroxydihydrochalcones, such as for example phloretin, davidigenin (in particular as described in U.S. Provisional Application 60/894,557, which is incorporated into this application by way of reference with regard to the corresponding compounds disclosed therein);
and optionally
(iii) one or more further aroma substances, wherein preferably at least one aroma substance is an aroma substance which suppresses malodors and optionally
(iv) one or more auxiliary substances or carriers.

Preference is given to an aroma composition according to the invention, wherein one, several or all of the salivatory aroma substances and/or flavorings are trigeminally active.

Preference is further given to an aroma composition according to the invention, wherein one, several or all of the salivatory aroma substances and/or flavorings are in each case

(a) warmth-inducing or pungent substances, preferably selected from the list consisting of: capsaicinoids, such as for example capsaicin, dihydrocapsaicin or nonivamide; gingerols, such as for example gingerol-6, gingerol-8, or gingerol-10; gingerdiones, such as for example gingerdione-6, gingerdione-8 or gingerdione-10; paradols, such as for example paradol-6, paradol-8 or paradol-10; dehydrogingerdiones, such as for example dehydrogingerdione-6, dehydrogingerdione-8 or dehydrogingerdione-10; piperine and piperine derivatives;
and/or
(b) substances perceivable as pungent, preferably selected from the group consisting of: aromatic isothiocyanates, such as for example phenylethyl isothiocyanate, allyl isothiocyanate, cyclopropyl isothiocyanate, butyl isothiocyanate, 3-methylthiopropyl isothiocyanate, 4-hydroxybenzyl isothiocyanate, 4-methoxybenzyl isothiocyanate;
and/or
(c) are substances which trigger a physiological cooling effect, preferably selected from the group consisting of menthol; menthol derivatives such as for example L-menthol, D-menthol, racemic menthol, isomenthol, neoisomenthol, neomenthol; menthyl ethers, such as for example (L-menthoxy)-1,2-propanediol, (L-menthoxy)-2-methyl-1,2-propanediol, L-menthyl methyl ether; menthyl esters, such as for example menthyl formate, menthyl acetate, menthyl isobutyrate, menthyl lactate, L-menthyl L-lactate, L-menthyl D-lactate, L-menthyl (2-methoxy)acetate, L-menthyl (2-methoxyethoxy)acetate, L-menthyl pyroglutamate; menthyl carbonates, such as for example L-menthyl propylene glycol carbonate, L-menthyl ethylene glycol carbonate, L-menthyl glycerol carbonate or mixtures thereof; semi-esters of menthols with a dicarboxylic acid or the derivatives thereof, such as for example mono-L-menthyl succinate, mono-L-menthyl glutarate, mono-L-menthyl malonate, O-L-menthyl succinate N,N-dimethyl)amide, O-L-menthyl succinamide; menthane carboxamides, such as for example L-menthane carboxylic acid N-ethylamide [WS3], N^{α}-(L-menthane carbonyl)glycine ethyl ester [WS5], L-menthane carboxylic acid N-(4-cyanophenyl)amide, L-menthane carboxylic acid N-(alkoxyalkyl)amides, L-menthane carboxylic acid N-(alkylthioalkyl)amides (in particular as described in U.S. Provisional Application 60/803,645, which is incorporated into this application by way of reference with regard to the corresponding compounds disclosed therein); (L-menthane carbonyl)amino acid alkylamides (in particular as described in U.S. Provisional Application 60/829,953, which is incorporated into this application by way of reference with regard to the corresponding compounds disclosed therein); menthone and menthone derivatives, such as for example L-menthone glycerol ketal; 2,3-dimethyl-2-(2-propyl)-butanoic acid derivatives, such as for example 2,3-dimethyl-2-(2-propyl)-butanoic acid N-methylamide [WS23]), isopulegol and its esters (L-(−)-isopulegol, L-(−)-isopulegol acetate; menthane derivatives, such as for example p-menthane-3,8-diol; cubebol and synthetic and natural mixtures containing cubebol; pyrrolidone derivatives of cycloalkyldione derivatives, such as for example 3-methyl-2(1-pyrrolidinyl)-2-cyclopenten-1-one) and tetrahydropyrimidin-2-ones, such as for example icilin or related compounds (in particular as described in WO 2004/026840, which is incorporated into this application by way of reference with regard to the corresponding compounds disclosed therein),
and/or
(d) are alkamides described as tingling, selected from the group consisting of 2E,4E-decadienoic acid N-isobutylamide (trans-pellitorine) (in particular as described in WO 2004/043906, which is incorporated into this application by way of reference with regard to the corresponding compounds disclosed therein); 2E,4Z-decadienoic acid N-isobutylamide (cis-pellitorine) (in particular as described in WO 2004/000787, which is incorporated into this application by way of reference with regard to the corresponding compounds disclosed therein); 2Z,4Z-decadienoic acid N-isobutylamide; 2Z,4E-decadienoic acid N-isobutylamide; 2E,4E-decadienoic acid N-([2S]-2-methylbutyl)amide; 2E,4E-decadienoic acid N-([2S]-2-methylbutyl)amide; 2E,4E-decadienoic acid N-([2R]-2-methylbutylamide); 2E,4Z-decadienoic acid N-(2-methylbutyl)amide; 2E,4E-decadienoic acid N-piperide (achilleamide); 2E,4E-decadienoic acid N-piperide (sarmentine); 2E-decenoic acid N-isobutylamide; 3E-decenoic acid N-isobutylamide; 3E-nonenoic acid N-isobutylamide; 2E,6Z,8E-decatrienoic acid N-isobutylamide (spilanthol); 2E,6Z,8E-decatrienoic acid N-([2S]-2-methylbutyl)amide (homospilanthol); 2E,6Z,8E-decatrienoic acid N-([2R]-2-methylbutyl)amide; 2E-decen-4-ynoic acid N-isobutylamide; 2Z-decen-4-ynoic acid N-isobutylamide; 2E,6Z,8E,10E-dodecatetraenoic acid N-(2-methylpropyl)amide (α-sanshool); 2E,6Z,8E,10E-dodecatetraenoic acid N-(2-hydroxy-2-methylpropyl)amide α-hydroxysanshool); 2E,6E,8E,10E-dodecatetraenoic acid N-(2-hydroxy-2-methylpropyl)amide (γ-hydroxysanshool); 2E,4E,8Z,10E,12E-tetradecapentaenoic acid N-(2-hydroxy-2-methylpropyl)amide (γ-hydroxysanshool); 2E,4E,8E,10E,12E-tetradecapentaenoic acid N-(2-hydroxy-2-methylpropyl)amide (γ-hydroxyisosanshool); 2E,4E,8Z,10E,12E-tetradecapentaenoic acid N-(2-methyl-2-propenyl)amide (γ-dehydrosanshool); 2E,4E,8Z,10E,12E-tetradecapentaenoic acid N-(2-methylpropyl)amide (γ-sanshool); 2E,4E,8Z,11Z-tetradecatetraenoic acid N-(2-hydroxy-2-methylpropyl)amide (bungeanool); 2E,4E,8Z,11E-tetradecatetraenoic acid N-(2-hydroxy-2-methylpropyl)amide (isobungeanool); 2E,4E,8Z-tetradecatrienoic acid N-(2-hydroxy-2-methylpropyl)amide (dihydrobungeanool) and 2E,4E-tetradecadienoic acid N-(2-hydroxy-2-methylpropyl)amide (tetrahydrobungeanool).

Particular preference is given to an aroma composition according to the invention, wherein in each case

(i) one, several or all of the salivatory aroma substances and/or flavorings are selected from the group consisting of 2E,4E-decadienoic acid N-isobutylamide (trans-pellitorine), 2E,4Z-decadienoic acid N-isobutylamide (cis-pellitorine), 2Z,4Z-decadienoic acid N-isobutylamide, 2Z,4E-decadienoic acid N-isobutylamide, 2E,4E-decadienoic acid N-piperide (achilleamide), 2E,6Z,8E-decatrienoic acid N-isobutylamide (spilanthol), 2E,6Z,8E-decatrienoic acid N-([2S]-2-methylbutyl)amide (homospilanthol), 2E,6Z,8E-decatrienoic acid N-([2R]-2-methylbutyl)amide, 2E,6Z,8E,10E-dodecatetraenoic acid N-(2-methylpropyl)amide. (α-sanshool), 2E,6Z,8E,10E-dodecatetraenoic acid N-(2-hydroxy-2-methylpropyl)amide α-hydroxysanshool), 2E,4E,8Z,10E,12E-tetradecapentaenoic acid N-(2-methylpropyl)amide (γ-sanshool) and 2E,4E,8Z,11Z-tetradecatetraenoic acid N-(2-hydroxy-2-methylpropyl)amide (bungeanool) and in each case
(ii) one, several or all of the bitterness-masking aroma substances and/or flavorings are selected from the group consisting of eriodictyol, homoeriodictyol or the sodium salt thereof, 2,4-dihydroxybenzoic acid vanillylamide, 2,4,6-trihydroxybenzoic acid N-(4-hydroxy-3-methoxybenzyl)amide, 2,4-dihydroxybenzoic acid N-(4-hydroxy-3-methoxybenzyl)amide monosodium salt gingerdione-[2], gingerdione-[3], gingerdione-[4], dehydrogingerdione-[2], dehydrogingerdione-[3], dehydrogingerdione-[4]), diacetyl trimers, γ-aminobutyric acid, divanillin, phloretin and davidigenin.

Very particular preference is given to an aroma composition according to the invention, wherein in each case

(i) one, several or all of the salivatory aroma substances and/or flavorings are selected from the group consisting of 2E,4E-decadienoic acid N-isobutylamide (pellitorine), 2E,4Z-decadienoic acid N-isobutylamide (cis-pellitorine), 2Z,4Z-decadienoic acid N-isobutylamide, 2Z,4E-decadienoic acid N-isobutylamide, 2E,6Z,8E-decatrienoic acid N-isobutylamide (spilanthol), 2E,6Z,8E,10E-dodecatetraenoic acid N-(2-methylpropyl)amide (α-sanshool) and ˜2E,4E,8Z,11Z-tetradecatetraenoic acid N-(2-hydroxy-2-methylpropyl)amide (bungeanool) and in each case
(ii) one, several or all of the bitterness-masking aroma substances and/or flavorings are selected from the group consisting of eriodictyol, homoeriodictyol or the sodium salts thereof, 2,4-dihydroxybenzoic acid vanillylamide, gingerdione-[2], gingerdione-[3], phloretin and davidigenin.

It has surprisingly been found that the aroma compositions according to the invention may reduce or even completely suppress a bitter and at the same time an astringent impression of a plurality of compounds (also in corresponding mixtures). The impression perceived as bitter and simultaneously astringent is here reduced by modification, masking or lessening. The invention also includes a corresponding reduction or suppression of the corresponding (taste) impression even when this is generated by a compound only in combination with other compounds (in a substance mixture). For the purposes of the invention, reduction also includes toning down a bitter, astringent aftertaste.

For the purposes of the present text, those compounds are trigeminally active which are capable of imparting in the oral cavity a warming, spicy hot, pungent, cooling and/or tingling impression.

For the (i) salivatory and trigeminally active aroma substances and/or flavorings, some natural sources, primarily plant extracts are known and may be used for the purposes of the invention. Particularly suitable for preferred salivatory and trigeminally active alkamides are plant extracts such as for example alkamide-containing pepper extract (Piper spp., in particular P. nigrum, P. hispidum, P. tuberculatum, P. longum, P. arboreum, P. futokadsura, P. guineense, P. sarmentosum or Piper nigrum, var. muntok, P. aff. pedicellatum), extracts of toothache grass (Ctenium aromaticum), extracts of tarragon (Artemisia dracunculus), pellitory root extracts (Anacyclus spp., in particular Anacylcus pyrethrum L.), echinacea extracts (Echinaceae spp., for example E. angustifolia), extracts of Szechuan pepper (Zanthoxylum spp., In particular Zanthoxylum piperitum, Z. clava-herculin, Z. bungeanum, Z. zanthoxyloides), Spilanthes or paracress extracts (Spilanthes spp., in particular Spilanthes acmella), extracts of Acmella spp. (for example A. ciliata), extracts of Achillea spp. (for example Achillea wilsoniana), extracts of Fagara species (Fagara zanthoxyloides), extracts of Heliopsis spp. (for example H. longipes), extracts of Cissampelos glaberrima, extracts of Dinosperma erythrococca, bark extracts of Esenbeckia alata and extracts of Stauranthus perforatus.

For the (ii) bitterness-masking aroma substances and/or flavorings, some natural sources, primarily plant extracts are likewise known and applicable, For eriodictyol and homoeriodictyol or the sodium salts thereof it is possible for the purposes of the invention to use, for example, extracts of Eriodictyon spp. preferably Eriodictyon californicum or E. angustifolium and for phloretin to use extracts of Malus app., primarily of apple tree products, for example apple bark extract or concentrated apple polyphenol extract, preferably apple bark extract treated enzymatically with glycosidases or with an acid or acidic ion exchanger or concentrated apple polyphenol extract.

The plant extracts may be obtained from the corresponding fresh or dried plants or plant parts, in particular however from white, green or black peppercorns (P. nigrum), long pepper (P. longum), echinacea roots, pellitory root, Szechuan pepper, plant parts from the other Zanthoxylum species, plant parts from the Spilanthes or Acmella species, plant parts from the Fagara or Heliopsis species, plant parts from Eriodictyon spp. or Malus spp. Conventionally, the dried plant parts (for example fresh or dried roots, fruits, seeds, bark, wood, stalks, leaves or blossom [parts]), preferably in comminuted form, are extracted with a solvent suitable for foodstuffs and products consumed for pleasure at temperatures of from 0° C. to the boiling point of the respective solvent or solvent mixture, then filtered and the filtrate is wholly or partially evaporated, preferably by distillation, freeze drying or spray drying. The resultant raw extract may then be further worked up, for example treated enzymatically (for example with glycosidases to increase the yield of molecules not containing sugar), treated with acid (for example under pressure), with acidic ion exchangers or with steam, generally at pressures of from 0.01 mbar to 100 bar, preferably at 1 mbar to 20 bar, and/or redissolved in a solvent suitable for foodstuffs and products consumed for pleasure.

Solvents which are in particular suitable for foodstuffs and products consumed for pleasure are water, ethanol, methanol, propylene glycol, glycerol, acetone, dichloromethane, acetic acid ethyl ester, diethyl ether, hexane, heptane, triacetin, plant oils, or fats, supercritical carbon dioxide and mixtures thereof.

Preferred auxiliary substances or carriers are maltodextrin, starch, natural or artificial polysaccharides and/or vegetable gums such as modified starches or gum arabic, solvents approved for aroma compositions such as for example ethanol, 1,2-propylene glycol, water, glycerol, triacetin, plant oil triglycerides, coloring agents, for example approved food dyes, coloring plant extracts, stabilizers, preservatives, antioxidants, viscosity-influencing substances.

Preferred aroma substances which suppress malodors are vanillin, ethyl vanillin, ethyl vanillin isobutyrate (=3-ethoxy-4-isobutyryloxybenzaldehyde), Furaneol® (2,5-dimethyl-4-hydroxy-3(2H)-furanone) and derivatives (for example homofuraneol, 2-ethyl-4-hydroxy-5-methyl-3(2H)-furanone), homofuronol (2-ethyl-5-methyl-4-hydroxy-3(2H)-furanone and 5-ethyl-2-methyl-4-hydroxy-3(2H)-furanone), maltol and derivatives (for example ethylmaltol), coumarin and derivatives, gamma-lactones (for example gamma-undecalactone, gamma-nonalactone), delta-lactones (for example 4-methyl delta-lactone, massoilactone, delta-decalactone, tuberolactone), methyl sorbate, diacetyl, 4-hydroxy-2(or 5)-ethyl-5(or 2)-methyl-3(2H)-furanone, 2-hydroxy-3-methyl-2-cyclopentenones, 3-hydroxy-4,5-dimethyl-2(5H)-furanone, fruit esters and fruit lactones (for example acetic acid n-butyl ester, acetic acid isoamyl ester, propionic acid ethyl ester, butyric acid ethyl ester, butyric acid n-butyl ester, butyric acid isoamyl ester, 3-methylbutyric acid ethyl ester, n-ethyl hexanoate n-allyl hexanoate, n-hexanoic acid n-butyl ester, n-octanoic acid ethyl ester, ethyl-3-methyl-3-phenyl glycidate, ethyl-2-trans-4-cis-decadienoate), 4-(p-hydroxyphenyl)-2-butanone, 1,1-dimethoxy-2,2,5-trimethyl-4-hexane, 2,6-dimethyl-5-hepten-1-al and phenyl-acetaldehyde.

In a preferred aroma composition according to the invention, the components of group (i) are introduced in a ratio to the components of group (ii) of 1:1,000,000 to 1:1, preferably 1:10,000 to 1:10, particularly preferably 1:2,000 to 1:50, in each case relative to the ratio by weight of the two components.

It is preferred according to the invention for the components of group (iii), if present, to be introduced into the aroma composition according to the invention in a ratio of 10:1 to 1:10, wherein the ratio is the ratio by weight of the weight of the components of group (iii) to the sum of the weights of the components of groups (i) and (ii).

It is preferred according to the invention for the components of group (iv), if present, to be introduced according to the invention in a ratio of 1:1,000 to 1,000:1, preferably 1:100 to 100:1, wherein the ratio is the ratio by weight of the components of group (iv) to the sum of the weights of the components of groups (i), (ii) and (iii).

A particularly preferred aroma composition according to the invention comprises at least one component for enhancing a sweet, salty, optionally slightly sour and/or umami taste impression. The aroma compositions according to the invention are thus used in combination with at least one (further) substance suitable for enhancing a pleasant taste impression (sweet, salty, umami, optionally slightly sour). Preference is here given to salty tasting compounds/salt-enhancing compounds as disclosed in WO 2007/045566, which is incorporated into this application by way of reference with regard to these compounds, hesperitin as disclosed in WO 2007/014879, which is incorporated into this application by way of reference with regard to these compounds, or propenylphenyl glycosides (chavicol glycosides) as described in U.S. Provisional Application 60/886,548, which is incorporated into this application by way of reference with regard to these compounds, and umami compounds as described in U.S. Provisional Applications 60/829,958 and 60/916,589, which are incorporated into this application by way of reference with regard to these compounds.

A preferred aroma composition according to the invention additionally comprises at least one compound which may produce bitter, astringent impressions in the oral cavity, wherein these impressions are reduced and are preferably imperceptible as a result of the components of groups (i) and (ii) contained in the composition.

Examples of compounds which may produce bitter and simultaneously astringent and optionally cardboardy, dusty, dry, floury, rancid or metallic impressions in the oral cavity are: xanthine alkaloids, xanthines (caffeine, theobromine, theophylline and methylxanthines), alkaloids (quinine, brucine, strychnine, nicotine), phenolic glycosides (for example salicin, arbutin), flavonoid glycosides (for example neohesperidin, hesperidin, naringin, quercitrin, rutin, hyperosides, isoquercitrin, avicularin), isoflavonoids or the glycosides thereof (for example daidzin, genistin and the acyl or malonyl esters thereof), bitter tasting chalcones or chalcone glycosides (for example phloridzin, phloretin-2-O′-xyloglucoside), hydrolyzable tannins (gallic or ellagic acid esters of carbohydrates, for example pentagalloylglucose) non-hydrolyzable tannins (optionally galloylated catechins or epicatechins and the oligomers thereof, for example proanthyocyanidines or procyanidines, thearubigin), flavones (for example quercetin, taxifolin, myricetin), phenols such as for example salicin, polyphenols (for example hydroxycinnamic acids and the esters thereof such as γ-oryzanol, caffeic acid or the esters thereof, for example chlorogenic acid, neochlorogenic acid, cryptochlorogenic acid), terpenoid bitter substances (for example limonoids, such as limonin or nomilin from citrus fruits, lupolones and humulones from hops, iridoids, secoiridoids), triterpene glycosides such as P57A and related active ingredients from Hoodia gordonii, absinthin from wormwood, amarogehtin from gentian, metallic salts (in particular potassium, magnesium and calcium salts, potassium chloride, potassium gluconate, potassium carbonate, potassium sulfate, potassium lactate, potassium glutamate, potassium succinate, potassium malate, sodium sulfate, magnesium sulfate), pharmaceutical active ingredients (for example fluoroquinolone antibiotics, paracetamol, aspirin, β-lactam antibiotics, ambroxol, propylthiouracil [PROP], guaifenesin), vitamins (for example vitamin H, B-series vitamins such as vitamin B1, B2, B6, B12, niacin, pantothenic acid), denatonium benzoate, sucralose octaacetate, iron salts, aluminum salts, zinc salts, urea, unsaturated fatty acids, in particular unsaturated fatty acids in emulsions, bitter-tasting amino acids (for example leucine, isoleucine, valine, tryptophan, proline, histidine, tyrosine, lysine or phenylalanine) and bitter-tasting peptides (in particular peptides with an amino acid from the group comprising leucine, isoleucine, valine, tryptophan, proline or phenylalanine at the N or C terminus). Preferred substances which taste bitter, astringent, cardboardy, dusty, dry, floury; rancid or metallic are caffeine, theobromine and theophylline, quinine, salicin, arbutin, neohesperidin, naringin, quercitrin, rutin, daidzin, genistin and the acyl or malonyl esters thereof, phloridzin, gallic or ellagic acid esters of carbohydrates (for example pentagalloylglucose), optionally galloylated catechins or epicatechins, proanthyocyanidines or procyanidines, thearubigin, quercetin, taxifolin, myricetin, γ-oryzanol, caffeic acid or esters thereof (for example chlorogenic acid and isomers), limonoids such as limonin or nomilin from citrus fruits, lupolones and humulones from hops, triterpene glycosides such as P57A and related active ingredients from Hoodia gordonii, absinthin from wormwood, amarogentin from gentian, metallic salts (in particular potassium, magnesium and calcium salts, potassium chloride, potassium gluconate, potassium carbonate, potassium sulfate, potassium lactate, potassium glutamate, potassium succinate, potassium malate, sodium sulfate, magnesium sulfate) and pharmaceutical active Ingredients (for example fluoroquinolone antibiotics, paracetamol, aspirin, p-lactam antibiotics, ambroxol, propylthiouracil [PROP], guaifenesin).

Compounds which may produce a bitter, astringent and optionally cardboardy, chalky, dusty, dry, floury, rancid or metallic aftertaste in the oral cavity may be aroma substances or flavorings having a not unpleasant primary taste (for example sweet, salty, spicy, sour) and/or odor and may belong, for example, to the group comprising sweeteners, sugar substitutes or aroma substances. Examples which may be mentioned are: potassium salts (in particular potassium chloride, potassium gluconate, potassium carbonate, potassium sulfate, potassium lactate, potassium glutamate, potassium succinate, potassium malate), aspartame, neotame, superaspartame, saccharin, sucralose, tagatose, monellin, stevioside, rebaudioside, hemandulcin, thaumatin, miraculin, glycyrrhizin, glycyrrhetinic acid or derivatives thereof, cyclamate or the pharmaceutically acceptable salts of the above-mentioned compounds.

As already indicated further above, it has surprisingly been found that the aroma composition according to the invention may reduce or even completely suppress a bitter and simultaneously astringent impression the oral cavity, which is caused in particular by the stated compounds, in a plurality of substance mixtures, foodstuffs, pharmaceutical substances (medicaments) and products consumed for pleasure (particularly examples being tea-based, in particular green tea-based beverages, soy products, in particular soy milk products, cocoa-containing products, in particular chocolate).

In accordance with the above, the aroma compositions according to the invention are particularly suitable for combination with substance mixtures and preparations, in particular foodstuffs, pharmaceutical substances/medicaments, oral hygiene products or products consumed for pleasure, which contain, compounds which may produce a bitter, astringent and optionally cardboardy, chalky, dusty, dry, floury, rancid or metallic (after)taste in the oral cavity. Reference is here made in particular to the above list of examples of these compounds. The aroma compositions according to the invention are thus particularly suitable for combination with

(a) preparations which taste bitter and simultaneously astringent and optionally cardboardy, dusty, dry, floury, rancid and/or metallic and/or
(b) preparations that have a bitter and simultaneously astringent, cardboardy, dusty, dry, floury, rancid or metallic aftertaste.

The above-stated unpleasant tasting substances, substance mixtures or foodstuffs, medicaments or products consumed for pleasure may also have further generally not unpleasant taste and/or odor qualities. As further taste qualities which are not unpleasant for the purposes of the present invention, mention may be made, for example, of the impressions spicy, umami, sweet, salty and slightly sour.

Accordingly, the invention in part provides a preparation containing an aroma composition according to the invention.

Preferably, such a preparation is a pharmaceutical preparation, a semifinished product, intended for immediate nutrition or consumption, and/or a preparation serving for oral care.

Preference is given to preparations according to the invention wherein, relative to the total preparation, the concentration

of at least one, preferably of the total of all of the components of group (i), lies in the range from 0.005 to 5 ppm, preferably from 0.02 to 2-ppm, particularly preferably from 0.05 to 0.5 ppm and
the total of all the components of group (ii) lies in the range from 0.5 to 500 ppm, preferably from 10 to 200 ppm, particularly preferably from 20 to 100 ppm and preferably
the total of all the components of group (iii) lies in the range from 0.0005 to 500 ppm, preferably from 0.005 to 100 ppm, particularly preferably from 0.5 to 50 ppm.

Further preference is given to preparations according to the invention, wherein the total quantity of all the components (i), (ii) and (iii) relative to the total preparation lies in the range from 0.5 to 500 ppm, preferably in the range from 5 to 200 ppm, particularly preferably in the range from 10 to 100 ppm.

Particularly preferably, concentrations (relative to the ready-to-consume preparation containing the aroma compositions) here lie for (i) one or more of the salivatory, tingly-, spicy hot- and/or warm-tasting alkamides (salivatory aroma substances and/or flavorings), at equal to or below 0.5 ppm, wherein the intrinsic taste described as tingling, spicy hot, numbing or warm largely disappears, whereas the salivatory effect remains. Particularly effective masking is achieved in this way.

As already mentioned, one aspect of the present invention relates to the use of the aroma compositions according to the invention to mask or reduce the unpleasant taste impression of an unpleasant tasting substance, i.e. as flavor-correcting agents. Preferably, the aroma compositions according to the invention are introduced into a pharmaceutical preparation formulated for oral consumption or into a preparation serving for nutrition, oral care or pleasure, wherein the preparation conventionally comprises one or more unpleasant, i.e. bitter-, astringent-tasting substances.

Preparations according to the invention preferably comprise-0.000001 wt. % to 95 wt. %, relative to the total weight of the preparation, of an aroma composition according to the invention. In addition, one or more unpleasant tasting substances are usually present.

Particular preference is given to preparations according to the invention which comprise at least one bitter and one astringent-tasting substance, the amount of the bitter and of the astringent-tasting substance being sufficient to be perceived as an unpleasant taste in a comparison preparation not comprising any aroma composition according to the invention but otherwise Identically composed, and the amount of the aroma composition according to the invention in the preparation being sufficient to modify organoleptically, mask or reduce the unpleasant taste impression of the bitter and the astringent-tasting substance in comparison with the comparison preparation.

Preparations according to the invention may also take the form of a semifinished product, an odoriferous, aroma or flavoring substance composition or a seasoning mixture.

Preparations according to the invention which serve as semifinished products generally contain 0.0001 wt. % to 95 wt. %, preferably 0.001 to 80 wt. %, in particular 0.01 wt. % to 50 wt. %, relative to the total weight of the preparation, of an aroma composition according to the invention. Preparations according to the invention which are present as semifinished products may serve to mask or reduce the unpleasant taste impression of finished product preparations which are produced using the semifinished product preparation.

Preparations serving for nutrition or pleasure for the purposes of the invention are for example bakery products (for example bread, dry biscuits, cakes, other pastry products), confectionery (for example chocolates, chocolate bar products, other bar products, fruit gums, hard and soft caramels, chewing gum), alcoholic or non-alcoholic beverages (for example coffee, tea, wine, beverages containing wine, beer, beverages containing beer, liqueurs, spirits, brandies, fruit-containing carbonated beverages, isotonic beverages, soft drinks, nectars, fruit and vegetable juices, fruit or vegetable juice preparations), instant beverages (for example instant cocoa beverages, Instant tea beverages, Instant coffee beverages, instant fruit beverages), meat products (for example ham, fresh or cured sausage preparations, spiced or marinated fresh or cured meat products), eggs or egg products (dried egg, egg white, egg yolk), cereal products (for example breakfast cereals, muesli bars, precooked ready rice products), dairy products (for example milk beverages, buttermilk beverages, milk ice cream, yoghurt, kefir, curd cheese, soft cheese, hard cheese, dried milk powder, whey, butter, buttermilk, partially or fully hydrolyzed milk protein-containing products), products made from soy protein or other soybean fractions (for example soy milk and products made therefrom, fruit beverages with soy protein, soy lecithin-containing preparations, fermented products such as tofu or tempe or products made therefrom), fruit preparations (for example jams, fruit ice cream, fruit sauces, fruit fillings), vegetable preparations (for example ketchup, sauces, dried vegetables, deep-frozen vegetables, precooked vegetables, preserved vegetables), snack articles (for example baked or fried potato chips or potato dough products, maize- or peanut-based extrudates), fat- or oil-based products or emulsions thereof (for example mayonnaise, remoulade, dressings, other ready-to-serve meals and soups (for example dried soups, instant soups, precooked soups), spices, seasoning mixtures and in particular powdered seasonings, which are for example used in snack food applications. The preparations for the purposes of the invention may also be used as semifinished products for the production of further preparations serving for nutrition or for pleasure. The preparations for the purposes of the invention may also be nutritional supplements in the form of capsules, tablets (uncoated and coated tablets, for example coatings resistant to gastric juices), sugar-coated tablets, granules, pellets, mixtures of solids, dispersions in liquid phases, as emulsions, as powders, as solutions, as pastes or as other swallowable or chewable preparations.

Preparations according to the invention serving for oral care are in particular oral and/or dental care products such as toothpastes, tooth gels, tooth powders, mouthwashes, chewing gum and other oral care products.

Pharmaceutical preparations comprise a pharmaceutical active ingredient. Advantageous pharmaceutical active ingredients are for example steroidal antiinflammatory substances of the corticosteroid type, such as for example hydrocortisone, hydrocortisone derivatives such as hydrocortisone 17-butyrate, dexamethasone, dexamethasone phosphate, methylprednisolone or cortisone.

Advantageous nonsteroidal pharmaceutical active ingredients are for example antiinflammatory drugs such as oxicams such as piroxicam or tenoxicam; salicylates such as Aspirin® (acetylsalicylic acid), disalcid, solprin or fendosal; acetic acid derivatives such as diclofenac, fenclofenac, indomethacin, sulindac, tolmetin, or clindanac; fenamates such as mefenamic, meclofenamic, flufenamic or niflumic; propionic acid derivatives such as ibuprofen, naproxen, flurbiprofen, benoxaprofen or pyrazoles such as phenylbutazone, oxyphenylbutazone, febrazone or azapropazone.

Particularly preferred pharmaceutical preparations are products which are not available by prescription only and freely purchasable medicaments, i.e. OTC (“over the counter”) preparations, containing active ingredients such as paracetamol, acetylsalicylic acid or ibuprofen, vitamins (for example vitamin H, B-series vitamins such as vitamin B1, B2, B6, B12, niacin, pantothenic acid, preferably in the form of (effervescent) tablets or capsules), minerals (preferably in the form of (effervescent) tablets or capsules) such as iron salts, zinc salts, selenium salts, products containing active ingredients or extracts of ribwort (for example in cough syrup) or St. John's wort.

Further conventional active ingredients, basic materials, auxiliary substances and additives for preparations serving for nutrition, oral care or pleasure may be present in quantities of 5 to 99.999999 wt. %, preferably of 10 to 80 wt. %, relative to the total weight of the preparation. The preparations may furthermore comprise water in an amount of up to 99.999999 wt. %, preferably of 5 to 80 Wt. %, relative to the total weight of the preparation.

The preparations according to the invention, containing the aroma composition according to the invention, are produced according to a preferred development, by incorporating the constituents of groups (i), (ii) and optionally also (iii) of the aroma composition according to the invention as substances, as a solution or in the form of a mixture with a solid or liquid carrier, into a basic oral pharmaceutical preparation or a basic preparation serving for nutrition, oral care or pleasure.

Preparations according to the invention in the form of a solution may advantageously also be converted into a solid preparation by spray drying.

According to a further preferred embodiment, preparations according to the invention may be produced by incorporating the aroma composition according to the invention and optionally other constituents of the preparation according to the invention into emulsions, into liposomes, for example starting from phosphatidyl choline, into microspheres, into nanospheres or also into capsules, granules or extrudates prepared from a matrix suitable for foodstuffs and products consumed for pleasure, for example prepared from starch, starch derivatives, cellulose or cellulose derivatives (for example hydroxypropylcellulose), other polysaccharides (for example alginate), natural fats, natural waxes (for example beeswax, carnauba wax) or from proteins, for example gelatin.

In a further preferred production method, the aroma composition according to the invention is previously complexed with one or more suitable complexing agents, for example with cycloglycans, for example cyclofructans, cyclodextrins or cyclodextrin derivatives, preferably α-, γ- and β-cyclodextrin, and used in this complexed form.

One preparation which is particularly preferred according to the invention is one in which the matrix is so selected that the aroma composition according to the invention is released by the matrix in delayed manner, such that a longlasting effect is obtained.

The further constituents for preparations according to the invention may comprise conventional basic materials, auxiliary substances and additives for foodstuffs or products consumed for pleasure. Some of these substances have an unpleasant taste in that they have a bitter, astringent effect.

Examples of conventional basic materials, auxiliary substances and additives for preparations according to the invention are water, mixtures of fresh or processed, plant or animal basic or raw materials (for example raw, roasted, dried, fermented, smoked and/or boiled meat, bone, cartilage, fish, vegetables, fruit, herbs, nuts, vegetable or fruit juices or pastes or mixtures thereof), digestible or non-digestible carbohydrates (for example sucrose; maltose, fructose, glucose, dextrins, amylose, amylopectin, insulin, xylans, cellulose), sugar alcohols (for example sorbitol), natural or hardened fats (for example tallow, lard, palm fat, coconut oil, hardened vegetable fat), oils (for example sunflower oil, peanut oil, maize germ oil, olive oil, fish oil, soy oil, sesame oil), fatty acids or the salts thereof (for example potassium stearate), proteinogenic or non-proteinogenic amino acids and related compounds (for example taurine), peptides, native or processed proteins (for example gelatin), enzymes (for example peptidases), nucleic acids, nucleotides, taste-correcting agents for unpleasant taste impressions other than those described above, taste-correcting agents for further, generally not unpleasant taste impressions, taste-modulating substances (for example inositol phosphate, nucleotides such as guanosine monophosphate, adenosine monophosphate or other substances such as sodium glutamate or 2-phenoxypropionic acid), emulsifiers (for example lecithins, diacylglycerols), stabilizers (for example carageenan, alginate), preservatives, (for example benzoic acid, sorbic acid), antioxidants (for example tocopherol, ascorbic acid), chelating agents (for example citric acid), organic or Inorganic acidulants (for example malic acid, acetic acid, citric acid, tartaric acid, phosphoric acid), additional bitter substances (for example quinine, caffeine, limonin, amarogentin, humulone, lupulone, catechins, tannins), sweeteners (for example saccharin, cyclamate, aspartame, neotame), mineral salts (for example sodium chloride, potassium chloride, magnesium chloride, sodium phosphate), substances preventing enzymatic browning (for example sulfite, ascorbic acid), essential oils, plant extracts, natural or synthetic dyes or coloring pigments (for example carotenoids, flavonoids, anthocyans, chlorophyll and the derivatives thereof), spices, synthetic, natural or nature-identical aroma substances or odoriferous substances and odor-correcting agents.

Dental care products (as the basis for preparations serving for oral care) which contain the aroma composition according to the invention preferably comprise an abrasive system (abrasive or polishing agent), such as for example silicas, calcium carbonates, calcium phosphates, aluminum oxides and/or hydroxyapatites, surface-active substances such as for example sodium lauryl sulfate, sodium lauryl sarcosinate and/or cocamidopropyl betaine, humectants such as for example glycerol and/or sorbitol, thickeners, such as for example carboxymethylcellulose, polyethylene glycols, carrageenan and/or Laponite®, sweeteners, such as for example saccharin, other taste-correcting agents for unpleasant taste impressions, taste-correcting agents for further, generally not unpleasant taste impressions, taste-modulating substances (for example inositol phosphate, nucleotides such as guanosine monophosphate, adenosine monophosphate or other substances such as sodium glutamate or 2-phenoxypropionic acid), cooling active ingredients such as for example menthol, menthol derivatives (for example L-menthol, L-menthyl lactate, L-menthyl alkylcarbonates, menthone ketals, menthane carboxamides), 2,2,2-trialkylacetamides (for example 2,2-diisopropylpropionic acid methylamide), icilin derivatives, stabilizers and active ingredients, such as for example sodium fluoride, sodium monofluorophosphate, tin difluoride, quaternary ammonium fluorides, zinc citrate, zinc sulfate, tin pyrophosphate, tin dichloride, mixtures of different pyrophosphates, triclosan, cetylpyridinium chloride, aluminum lactate, potassium citrate, potassium nitrate, potassium chloride, strontium chloride, hydrogen peroxide, aromas, sodium bicarbonate and/or odor-correcting agents.

Chewing gums (as a further example of preparations serving for oral care) which contain aroma compositions according to the invention preferably comprise a chewing gum base, i.e. a chewable mass which becomes plastic on chewing, sugars of various kinds, sugar substitutes, sweeteners, sugar alcohols, other taste-correcting agents for unpleasant taste impressions, taste-correcting agents for further, generally not unpleasant taste impressions, taste-modulating substances (for example inositol Phosphate, nucleotides such as guanosine monophosphate, adenosine monophosphate or other substances, such as sodium glutamate or 2-phenoxypropionic acid), the cooling active ingredients, humectants, thickeners, emulsifiers, aromas, stabilizers and/or odor-correcting agents mentioned in the previous section.

Preferred preparations according to the invention are preparations serving for nutrition, oral, care or pleasure, with regard to the composition of which the above applies.

The preparations according to the invention serving for nutrition, oral care or pleasure are regularly products which are intended to be introduced into the human oral cavity, to remain there for a specific time and then either to be consumed (for example foodstuffs ready for consumption) or removed from the oral cavity again (for example chewing gum or toothpaste). It goes without saying that the aroma composition according to the invention is intended for use in every type of such products. These products include all substances or products which are intended to be taken into the human oral cavity in the processed, partially processed or unprocessed state. This category also includes substances which are added to foodstuffs during production, processing or treatment thereof and are intended to be introduced into the human oral cavity.

It goes without saying that the aroma composition according to the invention may be used in particular in foodstuffs. Within the context of the present text, “foodstuff” is taken to mean in particular substances which are intended to be swallowed by a person and then digested in an unmodified, prepared or processed state; foodstuffs are also understood in this respect to mean casings, coatings or other encapsulations which are intended also to be swallowed or for which swallowing is to be anticipated. Certain products which are conventionally removed again from the oral cavity (for example chewing gum) are understood in the context of the present text to be foodstuffs, since it is not to be ruled out that they will be swallowed at least in part.

In particular, the aroma compositions according to the invention are used in foodstuffs which are ready for consumption. A foodstuff which is ready for consumption should here be understood to mean a foodstuff which is already fully assembled with regard to the substances which decide taste. The phrase “foodstuff ready for consumption” also covers corresponding beverages and solid or semisolid foodstuffs ready for consumption. Examples which may be mentioned are deep-frozen products, which have to be thawed prior to consumption and heated to consumption temperature. Products such as yoghurt or ice cream and also chewing gum or hard caramels count as foodstuffs ready for consumption.

For the purposes of the invention, a preparation (oral care product, also known as oral hygiene product or oral hygiene preparation) serving for oral care is a preparation for cleaning and caring for the oral cavity and the pharynx and for freshening breath. This expressly includes care of the teeth and gums. Dosage forms of customary oral hygiene formulations are creams, gels, pastes, foams, emulsions, suspensions, aerosols, sprays and capsules, granules, pastilles, tablets, candies or chewing gums, this list being understood not to be limiting for the purposes of the present invention.

The aroma composition according to the invention may also be used, as already stated, in semifinished foodstuff products. The term semifinished foodstuff product relates to foodstuffs which are intended only to be consumed after further processing, for example after the addition of aroma or taste substances which are (co)decisive with regard to the organoleptic impression.

As stated above, part of the invention also relates to the use of an aroma composition according to the invention (preferably without a compound which may produce bitter, astringent impressions in the oral cavity) to reduce or suppress a bitter, astringent effect of a compound.

When used according to the invention, it may be advantageous for not all the bitter-tasting nuances (the same also applies optionally to the astringent effect) to be masked, since these may also be desirable under certain circumstances.

Part of the invention is also a method of reducing or suppressing the bitter, astringent effect of a compound, comprising the steps

a) providing a compound, which may have a bitter, astringent effect in the oral cavity,
b) providing an aroma composition according to the invention and
c) mixing the components provided in steps a) and b) in a ratio to one another such that the compound with the bitter, astringent effect displays this effect only to a lesser degree or not at all on introduction of the mixture into the oral cavity.

The invention will be explained further below with the assistance of examples and the claims. The examples serve to clarify the invention, without limiting the scope of protection of the claims.

### EXAMPLES

### Example of Application 1

### Aroma Compositions

| | Preparation (quantity used in wt. %) | | | | | | | |
|---|---|---|---|---|---|---|---|---|
| Constituent | A | B | C | D | E | F | G | H |
| 10 wt. % trans- | | | | 0.25 | 0.25 | 0.5 | 0.25 | |
| pellitorine (for | | | | | | | | |
| example according to WO | | | | | | | | |
| 2004/043906) in | | | | | | | | |
| 1,2-propylene | | | | | | | | |
| glycol/diethyl malonate | | | | | | | | |
| Approx. 1.3 wt. % | 2.5 | | 2.5 | | | | | 2.5 |
| pellitorine, spray- | | | | | | | | |
| dried | | | | | | | | |
| Jambu oleoresin, | | 0.1 | 0.1 | | | | | |
| containing 30 wt. % | | | | | | | | |
| spilanthol in 1,2- | | | | | | | | |
| propylene glycol | | | | | | | | |
| (Robertet) | | | | | | | | |
| Homoeriodictyol | 5 | | 2.5 | | | | | |
| Eriodictyol | | 2.5 | | | | | | |
| Phloretin | | | | 2.5 | | | | |
| Hesperetin | | | | | 1 | | | |
| γ-Aminobutyric acid | | | 1.5 | | | | | |
| 2,4-Dihydroxybenzoic | | | | | | 2.5 | | |
| acid N-vanillylamide | | | | | | | | |
| Gingerdione-[2] | | | | | | | | 2.5 |
| Diacetyl trimer | | | | | | | 0.5 | |
| Divanillin | | | | | | | | 0.5 |
| Propylene glycol | — | — | — | to | — | — | to | — |
| | | | | make | | | make | |
| | | | | up to | | | up to | |
| | | | | 100 | | | 100 | |
| Ethanol | — | to | — | — | to | to | — | — |
| | | make | | | make | make | | |
| | | up to | | | up to | up to | | |
| | | 100 | | | 100 | 100 | | |
| Maltodextrin | to | — | to | — | — | — | — | to |
| | make | | make | | | | | make |
| | up | | up to | | | | | up to |
| | to 100 | | 100 | | | | | 100 |

The substances or solutions are mixed in the above-stated quantity ratios and then redissolved with propylene glycol or ethanol and completely dissolved by gentle warming or mixed homogeneously with solid carriers.

### Example of Application 2

### Spray-Dried Aroma Compositions as Semifinished Products for Aromatizing Finished Products

| | Preparation (quantity used in wt. %) | | | | | | | |
|---|---|---|---|---|---|---|---|---|
| Constituent | A | B | C | D | E | F | G | H |
| Maltodextrin from wheat | 24.3 | 24.3 | 24.3 | 24.3 | 24.3 | 24.3 | 24.3 | 24.3 |
| Gum arabic | 6.1 | 6.1 | 6.1 | 6.1 | 6.1 | 6.1 | 6.1 | 6.1 |
| Trans-pellitorine | 0.08 | 0.08 | 0.06 | 0.06 | 0.04 | 0.06 | 0.06 | 0.06 |
| according to WO | | | | | | | | |
| 2004/043906 | | | | | | | | |
| Homoeriodictyol, | 8.8 | 4.4 | | 8.8 | | | 7.8 | |
| sodium salt | | | | | | | | |
| Eriodictyol | | 4.4 | | | | | | |
| Phloretin | | | 8.8 | | | | | |
| γ-Aminobutyric acid | | | | 2.0 | | | | |
| 2,4-Dihydroxy- | | | | | 8.8 | | | |
| benzoic acid N- | | | | | | | | |
| vanillylamide | | | | | | | | |
| Gingerdione-[2] | | | | | | 8.8 | | |
| Diacetyl trimer | | | | | | | 1.0 | |
| Divanillin | | | | | | | | 8.8 |
| Drinking water | to | to | to | to | to | to | to | to |
| | make | make | make | make | make | make | make | make |
| | up | up | up to | up to | up to | up to | up to | up to |
| | to 100 | to 100 | 100 | 100 | 100 | 100 | 100 | 100 |

The drinking water is initially introduced into a container and the maltodextrin and gum arabic are dissolved therein. Constituents are then emulsified with a mixer (Turrax) into the above-described carrier solution. The temperature of the resultant mixture should not exceed 30° C. The mixture is then spray-dried (specified inlet temperature: 185-195° C., specified outlet temperature: 70-75° C.). The spray-dried semifinished product contains approx. 18-22% of the aroma compositions according to the invention.

Spray-dried preparations may also be produced in a similar manner with other aroma compositions according to the invention.

### Example of Application 3

### Aroma Blends for Masking a Bitter, Astringent Taste

| | Preparation (quantity used in wt. %) | | | | | | | | | | | |
|---|---|---|---|---|---|---|---|---|---|---|---|---|
| Constituent | A | B | C | D | E | F | G | H | I | J | K | L |
| Symrise cream aroma, | 5.20 | | | | | | | | | | | |
| spray-dried | | | | | | | | | | | | |
| Symrise cream aroma in | | | | 1.50 | | 0.80 | | | | | | |
| 1,2-propylene glycol | | | | | | | | | | | | |
| Symrise sugar aroma, | | 10.50 | | | | | | | | | | |
| spray-dried | | | | | | | | | | | | |
| Symrise sugar aroma | | | 4.00 | | 1.50 | | | | | | | |
| Symrise citron aroma | | | | | | | 0.80 | | | | | |
| Symrise grapefruit aroma | | | | | | | | 10.0 | | | | |
| Symrise orange aroma | | | | | | | | 5.00 | | | | |
| Symrise lemon aroma | | | | | | | | | 30.0 | | | |
| Symrise ginger aroma | | | | | | | | | | | | 4.00 |
| Symrise lemon grass aroma | | | | | | | | | | | | 0.50 |
| Symrise mango aroma | | | | | | | | | | 3.50 | | |
| Symrise white peach aroma | | | | | | | | | | | 10.0 | |
| 10 wt. % pellitorine (for | 0.05 | 0.10 | 3.00 | 0.25 | 0.50 | 0.20 | 0.10 | 0.05 | 0.10 | 0.10 | 0.50 | 0.30 |
| example according to WO | | | | | | | | | | | | |
| 2004/043906) in 1,2- | | | | | | | | | | | | |
| propylene glycol/diethyl | | | | | | | | | | | | |
| malonate | | | | | | | | | | | | |
| Homoeriodictyol, sodium salt | 0.625 | 2.45 | | | 1.25 | | 2.50 | 0.625 | 2.45 | 1.25 | 5.00 | 2.50 |
| γ-Aminobutyric acid | | | | 1.00 | | 0.4 | | | | | | |
| Hesperetin | | | | | | 1.20 | | | | | | |
| Divanillin | | | 3.25 | | 1.25 | | | | | | | |
| Water | | | | 20 | | | | | | | | |
| 1,2-Propylene glycol | — | — | — | to | — | to | — | | | | | |
| | | | | make | | make | | | | | | |
| | | | | up to | | up to | | | | | | |
| | | | | 100 | | 100 | | | | | | |
| Maltodextrin | to | to | to | — | to | — | to | to | to | to | to | to |
| | make | make | make | | make | | make | make | make | make | make | make |
| | up to | up to | up to | | up to | | up to | up to | up to | up to | up to | up to |
| | 100 | 100 | 100 | | 100 | | 100 | 100 | 100 | 100 | 100 | 100 |

The substances or solutions are mixed in the above-stated quantity ratios and then redissolved with propylene glycol or ethanol and completely dissolved by gentle warming or mixed homogeneously with solid carriers.

### Example of Application 4

### Soy Milk Beverages

### Comparison Preparation (A)

Preparation according to the invention containing aroma compositions (B-D) according to the invention

| | Preparation (stated in wt. %) | | | |
|---|---|---|---|---|
| Constituent | A | B | C | D |
| Sucrose | 3% | 3% | 3% | 3% |
| Aroma composition | — | 0.2% | — | — |
| according to | | | | |
| example of | | | | |
| application 3 B | | | | |
| Aroma composition | — | — | 0.8% | — |
| according to | | | | |
| example of | | | | |
| application 3 D | | | | |
| Aroma composition | | — | — | 0.2% |
| according to | | | | |
| example of | | | | |
| application 3 F | | | | |
| Soy milk, Sojasun | to make | to make up to | to make up to | to make |
| brand, non- | up to | 100% | 100% | up to |
| aromatized and | 100% | | | 100% |
| unsweetened | | | | |

Compared with preparation A, astringency and bitterness were substantially less in preparations B-D. In preparation D the beany note was also reduced significantly.

### Example of Application 5

### Tea-Based Beverages

### Comparison Preparation (A)

Preparation according to the invention containing aroma compositions (B-D) according to the invention

Preparation (stated in wt. %)

| Constituent | A | B | C | D |
|---|---|---|---|---|
| Green tea extract, 80% | 0.25 | 0.25 | 0.25 | 0.25 |
| polyphenols | | | | |
| Malic acid, citric acid | 0.10 | 0.10 | 0.10 | 0.10 |
| Mixture of sweeteners | 0.01 | 0.01 | 0.01 | 0.01 |
| (aspartame, sucralose | | | | |
| 1:1) | | | | |
| Aroma composition | — | 0.2% | — | — |
| according to example of | | | | |
| application 3 G | | | | |
| Aroma composition | — | — | 0.2% | — |
| according to example of | | | | |
| application 3 K | | | | |
| Aroma composition | | — | — | 0.2% |
| according to example of | | | | |
| application 3 K | | | | |
| Water | to make | to make | to make | to make |
| | up to | up to | up to | up to |
| | 100% | 100% | 100% | 100% |

The green tea extract, acid and sweetener mixture as well as the aroma compositions were dissolved in water at a temperature of 80° C. and placed in bottles.

Compared with preparation A, astringency and bitterness were substantially less in preparations B-D.

### Example of Application 6

### Mixture for Sweetening Coffee Beverages

### Comparison Preparation (A)

Preparation according to the invention containing aroma compositions (B-D) according to the invention

| | Preparation (stated in wt. %) | | | |
|---|---|---|---|---|
| Constituent | A | B | C | D |
| Saccharin | 1.50 | 1.50 | 1.50 | 1.50 |
| Aroma composition | — | 1.00% | — | 2.00% |
| according to | | | | |
| example of | | | | |
| application 3 C | | | | |
| Aroma composition | — | — | 5.00% | — |
| according to | | | | |
| example of | | | | |
| application 3 E | | | | |
| Sorbitol | to make | to make up to | to make up to | to make |
| | up to | 100% | 100% | up to |
| | 100% | | | 100% |

Preparations A-D are apportioned in an amount of 1% into black coffee (freshly brewed).

Compared with preparation A (comparison), astringency and long-term sweetness were substantially reduced in preparations B-D. Metallic notes were also reduced. Preparation C also had a more typical sucrose taste.

### Example of Application 7

### Mixture for Reducing the Bitterness of Bitter Chocolate

### Comparison Preparation (A)

Preparation according to the invention containing aroma compositions (B-D) according to the invention

| | Preparation (stated in wt. %) | | | |
|---|---|---|---|---|
| Constituent | A | B | C | D |
| Aroma according to | — | 0.2 | 0.2 | 0.2 |
| example of application | | | | |
| 1, preparation A | | | | |
| Hesperetin, 18% | — | — | 0.03 | — |
| spray-dried on | | | | |
| maltodextrin/gum | | | | |
| arabic according to | | | | |
| WO 2007/014879 | | | | |
| Vanillin | — | — | — | 0.10 |
| Dark cocoa mass, | to make up to | to make | to make | to make |
| cocoa content at least | 100% | up to | up to | up to |
| 85% | | 100% | 100% | 100% |

The cocoa mass is melted at 40-45° C. in the drying cabinet and the solid aroma constituents are added and stirred in while the mixture is carefully stirred. The liquid cocoa mass is poured into molds and adjusted to room temperature by conventional cooling procedures.

The chocolates according to preparations B to D are distinctly less, bitter and astringent than those according to preparation A; preparation C is additionally markedly sweeter, and preparation, D is additionally significantly more mellow with regard to perceived aroma.

1. An aroma composition for reducing or suppressing a bitter, astringent impression in the oral cavity, comprising
(i) one or more salivatory aroma substances and/or flavorings and
(ii) one or more bitterness-masking aroma substances and/or flavorings in each case selected from the group consisting of nucleotides, such as for example adenosine 5′-monophosphate, cytidine 5′-monophosphate, inosine 5′-monophosphate, and the pharmaceutically acceptable salts thereof; lactisoles; 2,4-dihydroxybenzoic acid; 3-hydroxybenzoic acid; sodium salts, such as for example sodium chloride, sodium lactate, sodium citrate, sodium acetate, sodium gluconate; hydroxyflavanones, such as for example eriodictyol, homoeriodictyol, and the sodium salts thereof; hydroxybenzoic acid amides, such as for example 2,4-dihydroxybenzoic acid vanillylamide, 2,4-dihydroxybenzoic acid N-(4-hydroxy-3-methoxybenzyl)amide, 2,4,6-trihydroxybenzoic acid N-(4-hydroxy-3-methoxybenzyl)amide, 2-hydroxybenzoic acid N-(4-hydroxy-3-methoxybenzyl)amide, 4-hydroxybenzoic acid N-(4-hydroxy-3-methoxybenzyl)amide, 2,4-dihydroxybenzoic acid N-(4-hydroxy-3-methoxybenzyl)amide monosodium salt, 2,4-dihydroxybenzoic acid N-2-(4-hydroxy-3-methoxyphenyl)ethylamide, 2,4-dihydroxybenzoic acid N-(4-hydroxy-3-ethoxybenzyl)amide, 2,4-dihydroxybenzoic acid N-(3,4-dihydroxybenzyl)amide and 2-hydroxy-5-methoxy-N-[2-(4-hydroxy-3-methoxyphenyl)ethyl]amide; 4-hydroxybenzoic acid vanillylamide; hydroxydeoxybenzoins, such as for example 2-(4-hydroxy-3-methoxyphenyl)-1-(2,4,6-trihydroxyphenyl)ethanone, 1-(2,4-dihydroxyphenyl)-2-(4-hydroxy-3-methoxyphenyl)ethanone, 1-(2-hydroxy-4-methoxyphenyl)-2-(4-hydroxy-3-methoxyphenyl)ethanone; hydroxyphenyl alkanediones such as for example gingerdione-[2], gingerdione-[3], gingerdione-[4], dehydrogingerdione-[2], dehydrogingerdione-[3], dehydrogingerdione-[4]); diacetyl trimers; γ-aminobutyric acid; divanillins and 4-hydroxydihydrochalcones, such as for example phloretin, davidigenin;
and optionally
(iii) one or more further aroma substances, wherein preferably at least one aroma substance is an aroma substance which suppresses malodors
and optionally
(iv) one or more auxiliary substances or carriers.

2. The aroma composition as claimed in claim 1, wherein one, several or all of the salivatory aroma substances and/or flavorings are trigeminally active.

3. The aroma composition as claimed in claim 2, wherein one, several or all of the salivatory aroma substances and/or flavorings are in each case
(a) warmth-inducing or pungent substances, preferably selected from the list consisting of: capsaicinoids, such as for example capsaicin, dihydrocapsaicin or nonivamide; gingerols, such as for example gingerol-6, gingerol-8, or gingerol-10; gingerdiones, such as for example gingerdione-6, gingerdione-8 or gingerdione-10; paradols, such as for example paradol-6, paradol-8 or paradol-10; dehydrogingerdiones, such as for example dehydrogingerdione-6, dehydrogingerdione-8 or dehydrogingerdione-10; piperine and piperine derivatives;
and/or
(b) substances perceivable as pungent, preferably selected from the group consisting of: aromatic isothiocyanates, such as for example phenylethyl isothiocyanate, allyl isothiocyanate, cyclopropyl isothiocyanate, butyl isothiocyanate, 3-methylthiopropyl isothiocyanate, 4-hydroxybenzyl isothiocyanate, 4-methoxybenzyl isothiocyanate;
and/or
(c) are substances which trigger a physiological cooling effect, preferably selected from the group consisting of menthol; menthol derivatives such as for example l-menthol, d-menthol, racemic menthol, isomenthol, neoisomenthol, neomenthol; menthyl ethers, such as for example (L-menthoxy)-1,2-propanediol, (L-menthoxy)-2-methyl-1,2-propanediol, L-menthyl methyl ether; menthyl esters, such as for example menthyl formate, menthyl acetate, menthyl isobutyrate, menthyl lactate, L-menthyl L-lactate, L-menthyl D-lactate, menthyl (2-methoxy)acetate, menthyl (2-methoxyethoxy)acetate, L-menthyl pyroglutamate; menthyl carbonates, such as for example L-menthyl propylene glycol carbonate, L-menthyl ethylene glycol carbonate, L-menthyl glycerol carbonate or mixtures thereof; semi-esters of menthols with a dicarboxylic acid or the derivatives thereof, such as for example mono-L-menthyl succinate, mono-L-menthyl glutarate, mono-L-menthyl malonate, O-L-menthyl succinate N,N-(dimethyl)amide, O-L-menthyl succinamide; menthane carboxamides, such as for example L-menthane carboxylic acid N-ethylamide [WS3], N^{α}-(L-menthane carbonyl)glycine ethyl ester [WS5], L-menthane carboxylic acid N-(4-cyanophenyl)amide, L-menthane carboxylic acid N-(alkoxyalkyl)amides, L-menthane carboxylic acid N-(alkylthioalkyl)amides; (L-menthane carbonyl)amino acid alkylamides; menthone and menthone derivatives, such as for example L-menthone glycerol ketal; 2,3-dimethyl-2-(2-propyl)-butanoic acid derivatives, such as for example 2,3-dimethyl-2-(2-propyl)-butanoic acid N-methylamide [WS23]), isopulegol and its esters (L-(−)-isopulegol, L-(−)-isopulegol acetate; menthane derivatives, such as for example p-menthane-3,8-diol; cubebol and synthetic and natural mixtures containing cubebol; pyrrolidone derivatives of cycloalkyldione derivatives, such as for example 3-methyl-2(1-pyrrolidinyl)-2-cyclopenten-1-one) and tetrahydropyrimidin-2-ones, such as for example icilin or related compounds,
and/or
d) alkamides described as tingling, selected from the group consisting of 2E,4E-decadienoic acid N-isobutylamide (trans-pellitorine); 2E,4Z-decadienoic acid N-isobutylamide (cis-pellitorine); 2Z,4Z-decadienoic acid N-isobutylamide; 2Z,4E-decadienoic acid N-isobutylamide; 2E,4E-decadienoic acid N-([2S]-2-methylbutyl)amide; 2E,4E-decadienoic acid N-([2S]-2-methylbutyl)amide; 2E,4E-decadienoic acid N-([2R]-2-methylbutylamide); 2E,4Z-decadienoic acid N-(2-methylbutyl)amide; 2E,4E-decadienoic acid N-piperide (achilleamide); 2E,4E-decadienoic acid N-piperide (sarmentine); 2E-decenoic acid N-isobutylamide; 3E-decenoic acid N-isobutylamide; 3E-nonenoic acid N-isobutylamide; 2E,6Z,8E-decatrienoic acid N-isobutylamide (spilanthol); 2E,6Z,8E-decatrienoic acid N-([2S]-2-methylbutyl)amide (homospilanthol); 2E,6Z,8E-decatrienoic acid N-([2R]-2-methylbutyl)amide; 2E-decen-4-ynoic acid N-isobutylamide; 2Z-decen-4-ynoic acid N-isobutylamide; 2E,6Z,8E,10E-dodecatetraenoic acid N-(2-methylpropyl)amide (α-sanshool); 2E,6Z,8E,10E-dodecatetraenoic acid N-(2-hydroxy-2-methylpropyl)amide α-hydroxysanshool); 2E,6E,8E,10E-dodecatetraenoic acid N-(2-hydroxy-2-methylpropyl)amide (γ-hydroxysanshool); 2E,4E,8Z,10E,12E-tetradecapentaenoic acid N-(2-hydroxy-2-methylpropyl)amide (γ-hydroxysanshool); 2E,4E,8E,10E,12E-tetradecapentaenoic acid N-(2-hydroxy-2-methylpropyl)amide (γ-hydroxyisosanshool); 2E,4E,8Z,10E,12E-tetradecapentaenoic acid N-(2-methyl-2-propenyl)amide (γ-dehydrosanshool); 2E,4E,8Z,10E,12E-tetradecapentaenoic acid N-(2-methylpropyl)amide (γ-sanshool); 2E,4E,8Z,11Z-tetradecatetraenoic acid N-(2-hydroxy-2-methylpropyl)amide (bungeanool); 2E,4E,8Z,11E-tetradecatetraenoic acid N-(2-hydroxy-2-methylpropyl)amide (isobungeanool); 2E,4E,8Z-tetradecatrienoic acid N-(2-hydroxy-2-methylpropyl)amide (dihydrobungeanool) and 2E,4E-tetradecadienoic acid N-(2-hydroxy-2-methylpropyl)amide (tetrahydrobungeanool).

4. The aroma composition as claimed in any one of the preceding claims, wherein in each case
(i) one, several or all of the salivatory aroma substances and/or flavorings are selected from the group consisting of 2E,4E-decadienoic acid N-isobutylamide (trans-pellitorine), 2E,4Z-decadienoic acid N-isobutylamide (cis-pellitorine), 2Z,4Z-decadienoic acid N-isobutylamide, 2Z,4E-decadienoic acid. N-isobutylamide, 2E,4E-decadienoic acid N-piperide (achilleamide), 2E,6Z,8E-decatrienoic acid N-isobutylamide (spilanthol), 2E,6Z,8E-decatrienoic acid N-([2S]-2-methylbutyl)amide (homospilanthol), 2E,6Z,8E-decatrienoic acid N-([2R]-2-methylbutyl)amide, 2E,6Z,8E,10E-dodecatetraenoic acid N-(2-methylpropyl)amide (α-sanshool), 2E,6Z,8E,10E-dodecatetraenoic acid N-(2-hydroxy-2-methylpropyl)amide (α-hydroxysanshool), 2E,4E,8Z,10E,12E-tetradecapentaenoic acid N-(2-methylpropyl)amide (γ-sanshool) and 2E,4E,8Z,11Z-tetradecatetraenoic acid N-(2-hydroxy-2-methylpropyl)amide (bungeanool) and in each case
ii) one, several or all of the bitterness-masking aroma substances and/or flavorings are selected from the group consisting of eriodictyol, homoeriodictyol or the sodium salts thereof, 2,4-dihydroxybenzoic acid vanillylamide, 2,4,6-trihydroxybenzoic acid N-(4-hydroxy-3-methoxybenzyl)amide, 2,4-dihydroxybenzoic acid N-(4-hydroxy-3-methoxybenzyl)amide monosodium salt, gingerdione-[2], gingerdione-[3], gingerdione-[4], dehydrogingerdione-[2], dehydrogingerdione-[3], dehydrogingerdione-[4], diacetyl trimers, γ-aminobutyric acid, divanillin, phloretin and davidigenin.

5. The aroma composition as claimed in any one of the preceding claims, wherein in each case
(i) one, several or all of the salivatory aroma substances and/or flavorings are selected from the group consisting of 2E,4E-decadienoic acid N-isobutylamide (pellitorine), 2E,4Z-decadienoic acid N-isobutylamide (cis-pellitorine), 2Z,4Z-decadienoic acid N-isobutylamide, 2Z,4E-decadienoic acid N-isobutylamide, 2E,6Z,8E-decatrienoic acid N-isobutylamide (spilanthol), 2E,6Z,8E,10E-dodecatetraenoic acid N-(2-methylpropyl)amide (α-sanshool) and 2E,4E,8Z,11Z-tetradecatetraenoic acid N-(2-hydroxy-2-methylpropyl)amide (bungeanool) and in each case
(ii) one, several or all of the bitterness-masking aroma substances and/or flavorings are selected from the group consisting of eriodictyol, homoeriodictyol or the sodium salts thereof, 2,4-dihydroxybenzoic acid vanillylamide, gingerdione-[2], gingerdione-[3], phloretin and davidigenin.

6. The aroma composition as claimed in any one of the preceding claims, wherein the components of group (i) are contained in a ratio to the components of group (ii) of 1:1,000,000 to 1:1, relative to the ratio by weight of the two components.

7. The aroma composition as claimed in any one of the preceding claims, wherein the aroma composition additionally comprises a component suitable for enhancing the taste impression umami, sweet, salty and/or slightly sour.

8. The aroma composition as claimed in any one of the preceding claims, wherein the aroma composition additionally comprises at least one compound which may produce bitter, astringent impressions in the oral cavity, wherein these impressions are reduced and are preferably imperceptible as a result of the components of groups (i) and (ii) contained in the composition.

9. A preparation comprising an aroma composition as claimed in any one of the preceding claims.

10. The preparation as claimed in claim 9, wherein the preparation is a pharmaceutical preparation, a semifinished product intended for immediate nutrition or consumption, and/or serving for oral care:

11. The preparation as claimed in claim 9 or claim 10, wherein relative to the total preparation, the concentration
of at least one, preferably of the total of all of the components of group (i), lies in the range from 0.005 to 5 ppm, preferably from 0.02 to 2 ppm, particularly preferably from 0.05 to 0.5 ppm and
the total of all the components of group (ii) lies in the range from 0.5 to 500 ppm, preferably from 10 to 200 ppm, particularly preferably from 20 to 100 ppm and preferably
the total of all the components of group (iii) lies in the range from 0.0005 to 500 ppm, preferably from 0.005 to 100 ppm, particularly preferably from 0.5 to 50 ppm.

12. The preparations as claimed in any one of claims 9 to 11, wherein the total quantity of all the components (i), (ii) and (iii) relative to the total preparation lies in the range from 0.5 to 500 ppm, preferably in the range from 5 to 200 ppm, particularly preferably in the range from 10 to 100 ppm.

13. Use of an aroma composition as claimed in any one of claims 1 to 8 for reducing or suppressing a bitter, astringent effect of a compound.

14. A method of reducing or suppressing the bitter, astringent effect of a compound, comprising the steps
a) providing a compound, which may have a bitter, astringent effect in the oral cavity,
b) providing an aroma composition according to the invention as claimed in any one of claims 1 to 8 and
c) mixing the components provided in steps a) and b) in a ratio to one another such that the compound with the bitter, astringent effect displays this effect only to a lesser degree or not at all on introduction of the mixture into the oral cavity.
